(19) United States
(12) Patent Application Publication
(10) Pub. No.: US 2006/0098005 A1
(43) Pub. Date: May 11, 2006

(54) Printing of holographic stereogram using desktop computer printer

(76) Inventor: Kwan Ming Yung, Dongguan Guangdong (CN)

Correspondence Address: KWAN MING YUNG, 8F, BLOCK 7, ZHENG DA CENTRE, DONG GUAN CITY, GUANDONG, 523000, CN

(21) Appl. No.: 11/164,143

(22) Filed: Nov. 11, 2005

Related U.S. Application Data
(63) Continuation of application No. 60/522,828, filed on Nov. 11, 2004.

(51) Int. Cl. B32B 37/00; B41J 2/32; G09G 5/02

(52) U.S. Cl. 345/418; 156/281; 156/277; 347/171; 345/589

(57) ABSTRACT

Methods and devices for making holographic stereogram using electronic desktop printers are disclosed. A new printing medium comprising microscopic arrays of embossed holographic optical elements is provided. Methods of mass printing such stereographic images directly or indirectly are also disclosed.

### (1) CROSS REFERENCE TO RELATED APPLICATIONS

Reference is made to and priority claimed from two U.S. Utility Patent applications. One is Ser. No. 11/160,882, filed on Jul. 14, 2005, titled “Hot stamp laser printer and hot stamp photocopier” and the other one is Ser. No. 11/161,354, filed on Jul. 30, 2005, entitled “Inkjet transfer printer.” In both utility patent applications, methods of using holographic transfer foil as print medium in laser printer and inkjet printer are disclosed. Said applications are hereby incorporated by reference herein in its entirety.

### (2) FIELD OF THE INVENTION

The present invention relates in general to holographic stereogram, and more particularly to a new printing medium and method that can be used in Black and White desktop computer printers to print holographic stereogram.

### (3) PRIOR ART

(a) Embossed Hologram

Embossed hologram is playing an important role in the security and promotion labels industry. The art of the mass production process starts with the making of a master hologram using Helium Cadmium laser and optical setup including an isolation table. The recording medium is a glass plate coated with a thin layer of photoresist that records the holographic images in the form of surface relief gratings. The plate is then silvered and electroplated to form nickel shims, from which millions of replication of the master images are copied onto aluminized polyester foil by embossing techniques. Detail description of this art is referred to McGrew, U.S. Pat. No. 4,589,686 issued May 1986.

While this technology has been carried out for more than 20 years, the art of holographic mastering continues to be substantial bottlenecks in the efficient use of such application. For example it may take several hours or even days for an experienced holographic technical staff to make just one single master, and in so doing a vast, delicate and expensive facility poses a great challenge to the manufacturer.

(b) Dot Matrix Holographic Mastering Technology

In the dot matrix holographic system, the image is synthesized by a plurality of tiny dots bearing patterns of diffraction grating of various frequency and pitches. However the need of sophisticated equipment, laser and optics in the manufacturing process of the print masters makes it obviate from being populated into a widely applicable means of printing. Until now such a technology is only confined to the making of masters for use in mass duplication of holographic security labels and promotional/packaging material.

(c) Digital Printing Device for Image-on-Paper Registration Printing.

In conventional printing processes, the text/image is normally printed onto a substrate bearing nothing but an empty space initially. In this regards there is no need to concern about the accurate positioning of the image. In some printing techniques, such as those employed in the present invention, an image is required to print onto a substrate over which there has already been imprinted with another pattern, and that the image and pattern should be precisely aligned with registration. This technique involves adjusting the position or timing of the images being formed on the pattern-bearing substrate, and can be done by controlling the raster output scanner imaging system.

Such a printing technique is called image-on-paper registration and is a known method as shown and described in U.S. Pat. No. 6,275,244 and is incorporated herein by reference in its entirety. In this digital printing method the image is printed successively by one or more electronic raster output scanner imagers that are incorporated with at least a start of scan sensor and an end of scan sensor. These sensors, together with the delay before the first pixel is imaged after the start of scan occurs, and the associated timing of when the start of scan occurs, provide the system for precision position printing.

### SUMMARY OF THE INVENTION

This invention makes use of the conventional desktop computer printers such as laser printer and inkjet printer to print holographic stereogram. In particular, the invention allows the use of embossed holographic foil as print medium in conventional desktop printers. In the present invention, there is no need to use holographic laser, optics, dark room facility, isolation environment and holographer to make hologram. This invention allows the printing of holographic stereogram in a simple way, as simple as printing texts in the office.

This invention provides methods to make holographic stereogram both in a two-steps process and a multiple-steps process.

In one aspect of the invention, a print medium in the form of embossed holographic foil is used to create holographic stereogram. This print medium, hereinafter called the HDOE (Holographic Diffractive Optical Element) is pre-embossed with interlacing arrays of diffract gratings comprising the three primary colors of red green and blue, each having a sequence of different diffractive directions.

In another aspect of the invention, the diffraction gratings are made into dot- or line-matrix format, similar to that used in the fluorescent elements of color monitors, TV screens and LCD. Each of the optical elements may take the shape of either circle, square, rectangle or line with a dimension below the resolution of naked eyes.

In a further aspect of the invention the HDOE is incorporated into different material such as aluminized polyester foil, BOPP, polycarbonate and Nickel plates.

In yet a further aspect of the invention there is provided with a computer graphic process to creating an achromatic, complex masking image for use in black-and-white desktop electronic printers.

In another aspect of the invention there is provided with a set of registration marks of crosshairs to be incorporated into the print media and the imaging processing software for precision position alignment in both the two-steps and multiple-steps technique.

In yet another aspect of the invention, the conventional offset printing method is used to produce holographic stereogram in a manner of large volume and high speed using the two-steps method.

### BRIEF DISCUSSION OF DRAWINGS

The invention can be more fully understood by reading the following detailed description of the preferred embodiments, with reference made to the accompanying drawings.

FIG. 1 is the top view of the holographic/diffractive optical element (HDOE) bearing mosaic of microscopic components and registration mark of crosshairs embodying the invention, (A) shows the interlacing lines manner and (B) shows the rectangular dots in closely packed manner.

FIG. 2 shows the flow chart about the operation of the Image Generating Software.

FIG. 3 illustrates the laminating device with facility of precise position registration for making stereogran in a multiple-steps process.

### DETAIL DESCRIPTION

This invention makes use of a subtractive mechanism to make stereogram onto a universal holographic print medium. This is done by printing a B/W masking image onto a print medium that is pre-embossed with micro-arrays of holographic diffractive optical elements (HDOE). In so doing the diffraction capability of portion of the HDOE are disabled. The remaining portions diffract the incident light to form a holographic stereogram according to the masking image.

The subtractive mechanism can either be accomplished directly by the masking image itself that cover part of the HDOE foil, or by a subsequent de-metal process in which the aluminum layer in part of the image area on the foil is removed using hydrofluoric acid. The masking image is a composite B/W monochrome image in half-tone gray scale manner that comprises all the image components constituting to the stererogram. A variety of printers can be used to perform the subtractive printing job, such as inkjet printer, laser printer and offset printer.

In a major embodiment of the invention there is provided with the HDOE (Holographic/Diffractive Optical Element) comprising microscopic gratings components corresponding to the three primary colors diffracting at sequential angles. There are actually two different type of HDOE, one is the HOE (holographic optical element) and the other is DOE (diffractive optical element). The HOE belongs to an image plane rainbow hologram of a planar diffused object while the DOE is simply a linear diffraction grating. Although a hologram is involved in the HDOE, it provides no depth perception but only color and directionality information.

The HOE is advantageous in that it provides a wide viewing angle while the DOE offers a high diffraction efficient. Depending on the type of illumination to be used, either HOE or DOE may be employed in the present invention and therefore they are given a general name of HDOE. Various holographic methods can be employed to produce the HOE and DOE, the simplest way is to use the dot-matrix holographic technique as described in “Background of the Invention”. It is a standard holographic mastering procedures and therefore its detail will not be described herein.

The HDOE is made to illustrate the following spectrum and spectral range emitting towards the observer when it is illuminated by a light source incident at a certain angle, say about 35 degree from above.

(A) Blue color: 380 nm to 500 nm.

(B) Green color: 500 nm to 575 nm.

(C) Red color: 575 nm to 750 nm.

(D) Bandwidth within 30 to 50 nm.

The diffractive angles along the direction can have be ranged from −24 degree to +24 degree between left right along the horizontal direction, with diffractive angles for neighboring components being separated by about 8 degrees from each other. A registration test pattern comprises at least four crosshairs are incorporated into the sides or corners of the HDOE for precision alignment purposes.

Depending on the type of application, the HDOE pattern can be incorporated into either one of the following media:

(1) Aluminized polyester or BOPP foil using embossed holographic technique. The film is preferably to be at least 25 micron thick so that it will not be distorted easily. This film can provide print-on-demand stereogram using any desktop electronic printers.

(2) Polycarbonate film of at least 0.5 mm thick. It is made using planar type embossing technique or mold-injection technique to impress the surface relief pattern at the nickel master onto the polycarbonate film. The latter method is similar to that being used in producing CDs and VCDs. This polycarbonate HDOE film provides the print master for mass duplication of the stereogram.

(3) Nickel plate of at least 100 micron thick that is made by electroforming method. Again this medium provides the print master for mass duplication of the stereographic image with quality more superior than the polycarbonate film.

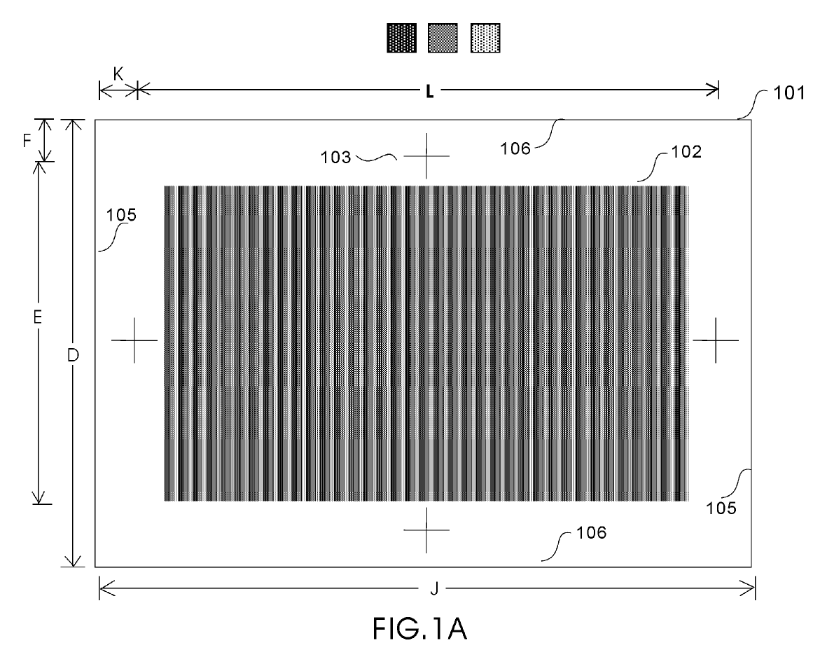

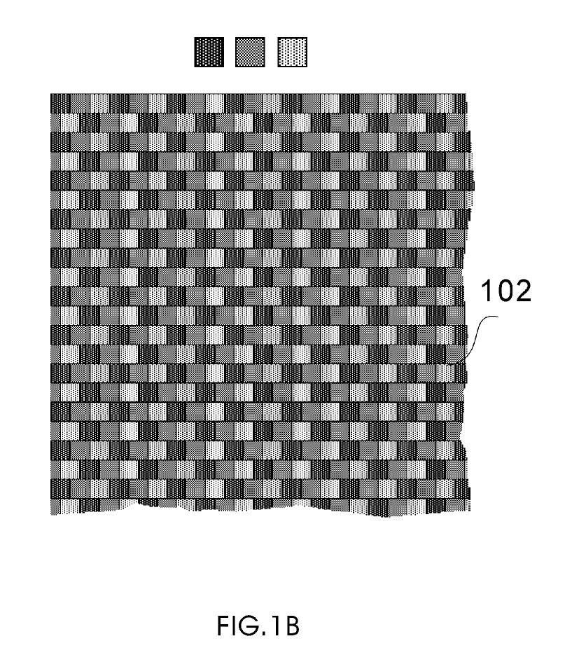

For illustrating purposes only a simple three-elements group is shown in FIG. 1A and FIG. 1B. The top view of the HDOE 101 as illustrated in FIG. 1A comprising the diffractive pattern 102 and a set of registration test pattern (crosshairs) 103. The microscopic diffractive patterns are presented in the form of interlacing thin lines. The diffractive elements with various optical characters are accommodated into a group, i.e. each group has optical elements corresponding to different colors and diffraction directions.

The number of elements in a group depends on the type of image that is to be produced, i.e. it is proportional to the amount of perspective views in the stereogram but is inversely proportional to the resolution of the image. (1) For making an auto-stereogram with mono-color, only two elements are needed, one for the left eye and the other for the right eye's observation. (2) For producing a simple plane color image, three elements representing red green and blue color are required. (3) For making an auto-stereogram with full-color, six elements are needed, one set of three (red green and blue color) caters for the left eye and the other set for the right eye's observation. (4) For making a mono-color stereogram with nine views, nine elements are needed; each element diffracts the incident light to different angles. There is about 8 degrees of diffracting angles separating from its neighboring ones along the horizontal direction.

The large plurality of groups is arranged in an alternatively interlacing manner more or less similar to those employed in the fluorescent tube of color video monitor screens or color LCD. The dimension of the lines in the diagram is highly exaggerated for the purpose of reviewing the details, while the actual dimension is preferable below the resolution of naked eye, which is about 254 dpi or 0.1 mm wide. An observer positioned at a certain distance from the image doesn't see the individual dot but rather perceives their cumulative effect, namely the optical elements are blended together to give a continuous image distribution with color and 3D features.

Other shapes of elements such as rectangular dots 102 in alternating interlace format can also be used for the HDOE, as shown in FIG. 1B.

The registration pattern 103 serves two purposes; (a) it provides a means for the visual alignment for the masking image film and the HDOE film in the multiple-steps process and (b) it provides landmark for the automatic scanning and sensing process in the two-steps image-on-paper printing.

The positional and dimensional information that are carried by the landmarks 103, 105, 106, together with the parameters D, E, F, J, K and L are designed to provide means for the specially equipped printers to perform image-on-paper printing automatically. The edges 105 and 106 of the film 101 refer to the direction that the sheet moves through the printers. “D” and “J” are respectively the length of the HDOE film 101 that run parallel and perpendicular to the feeding direction; “E” and “L” represent the distances between a pair of crosshairs in the vertical and horizontal direction respectively; while “F” and “K” represent respectively the distances of the edge of the HDOE 102 to the edge of the sheet 101 that run parallel and perpendicular to the feeding direction.

In another preferred embodiment of the present invention, there is provided with a software process named as Image Generating Software (IGS) to generate the masking image. There are two versions in the masking image, namely the positive and negative one. A positive masking image is defined as one that is depleted of toner or ink on bright image area, whereas a negative masking image is one that is depleted of toner or ink on dark image area. It is important to note that the dark and bright area mentioned herein is referring to the achromatic masking image itself only because as will be seen in the discussion that follow, the dark area in the masking image may result in bright image in the final hologram.

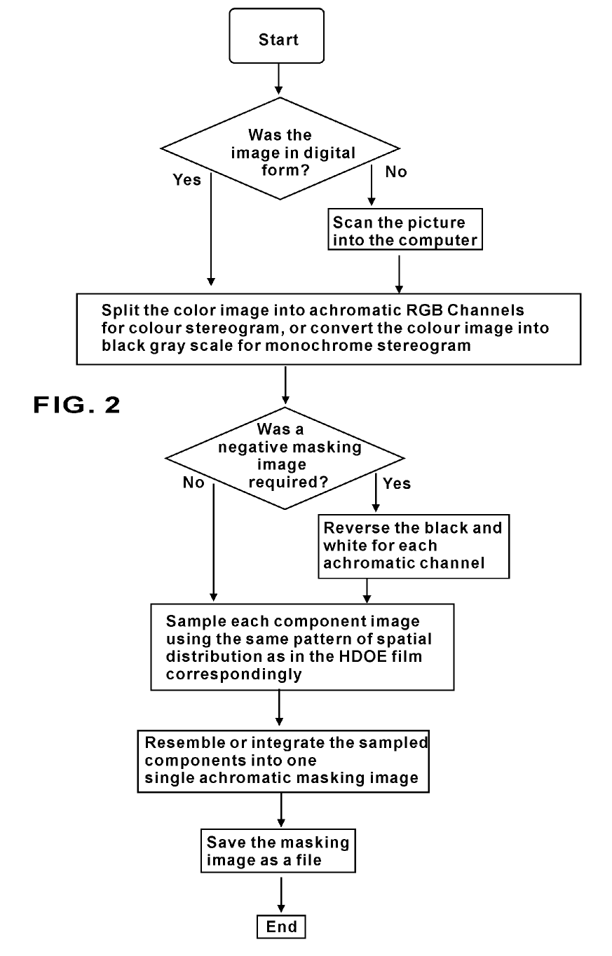

In all computerized graphic analysis used in this invention, the software program of “Photoshop 7.0” is adopted. The working mechanism of the IGS is explained in the computer flow chart in FIG. 2 comprising the steps of:

Scanning or digitizing the color images and save it into a computer image file. If the image is already in digital format then this step can be skipped.

Adjusting the brightness and contrast level of the image file accordingly and save it as appropriate image file of jpeg.

Splitting the color images into corresponding red green and blue channels in achromatic format, if a color stereogram is to be made; or converting the image into gray one for making a monochrome stereogram.

Reversing the gray-black image components if a negative masking image is to be used.

Sampling the individual gray image component into alternating lines or dots format using the same line width/dot size and spacing as those used in the elements of the HDOE in an alternating interlacing manner By way of a simple example, if there are a total of three image-components in a mono-color stereogram, and that a total of nine lines are in the HDOE, then each of the three image-components would be sliced into nine vertical line-zones. The first image component would be represented by line-zone of number 1, 4 and 7, the second image component represented by line-zone of number 2, 5 and 8 while the third image component represented by line-zone of number 3, 6 and 9, respectively.

Resembling all the three achromatic line-image components into one single

image hereinafter called the masking image. Take the example in (5), the

masking image would be constituted of line number 1, 4 and 7 of the first

image, line number 2, 4 and 6 of the second image and line number 3, 6 and 9

of the third image.

Several parameters are preferably to be incorporated into the IGS to facilitate precision alignment in the print/transfer processes, these are (a) the dimensions of the sampling lines or dots employed in making the masking images must match precisely with the same dimension and position of the optical elements that are employed in the HDOE film and (b) the same set of crosshairs presents in the HDOE film must be incorporated into the masking image. These parameters must be resident in the IGS software and be implemented as a portion of a program usable to form the overall image-forming engine.

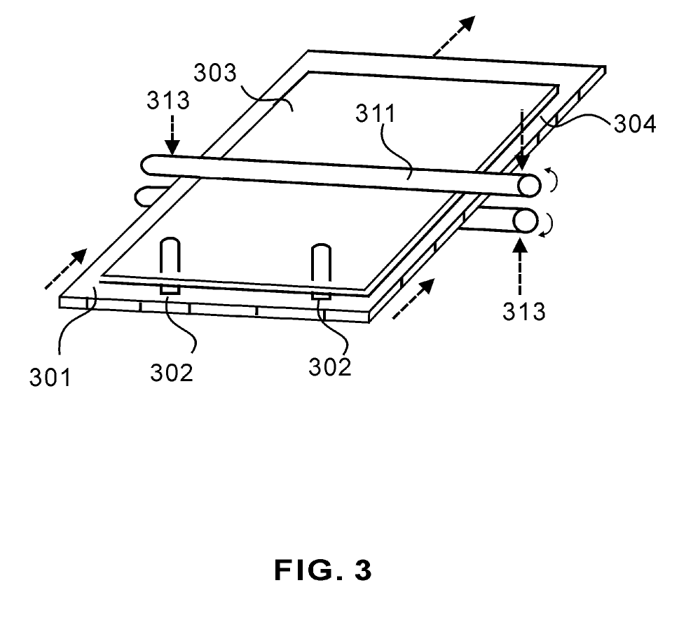

In another preferred embodiment of the present invention, there is provided with a device for precision alignment to the masking image with respective to the HDOE when making stereograms in multiple-steps, as shown in FIG. 3. A pin registration system commonly used in printing industry is incorporated into the laminating machine. The system comprises a mechanical punch (not shown) together with a pin-registration mounting jig 301 and the precision positioned pins 302. The masking image 303 and the HDOE 304 are first aligned manually according to the crosshairs. The two films are then punched with holes of precise position and dimension, which are subsequently mounted onto the pin registration jig 301 for laminating with precise accuracy in the alignment of the masking image with the HDOE. The rollers 311 and 313 provide heating and pressure to the laminating processes.

Now the disclosure is concentrated on the methods in producing stereographic images using the HDOE. In the disclosure hereinafter, there are three types of printer and three type of print medium involved in the printing process. The three printers are laser printer, inkjet printer and offset printer, while the three print media are polyester, polycarbonate and Nickel. The laser printer method is further classified into conventional type and special type; the latter, together with the inkjet printing method, are installed with image-on-paper facility.

In a preferred embodiment of the present invention, there is provided with methods and devices to make holographic stereogram on aluminized polyester film using desktop laser printers. At this point cross-reference is made to a previous U.S. patent application Ser. No. 11/160,882, filed on Jul. 14, 2005, entitled “Hot stamp laser printer and hot stamp photocopier.” In this application a method of adhering the aluminized polyester foil to paper substrates in order to prevent winkles from taking place when it is experiencing the intensive amount of heat during the fusing process in the laser printer. Another method regarding the image transferring mechanism using the laser printer is also incorporated by reference herein in its entirety.

There are two ways in executing this method, namely the two-steps and the multiple-steps technique.

A: The two-steps technique comprising the procedures of:

Printing a black-and-white negative masking image on HDOE foil using laser printer installed with image-on-paper precision printing facility. The printing is done on the aluminum side of the HDOE film, which can be a permanent type or hot stamping type of aluminized polyester foil.

Soaping the printed foil in dilute hydrochloric acid for a few seconds. The toner in the image area acts as protector to prevent the part of the aluminum underneath the particles from contacting to the chemical, while the aluminum on the part of foil where there is no image will be dissolved, rendering that part non-reflective and become transparent. Finally the foil is laminated onto a black paper or plastic substrate using transparent adhesive such as 3M 467 double sided cello-tape, with the side printed with toner particles facing the adhesive, to review the stereogram.

B: The multiple-steps technique comprises procedures of:

Printing a black-and-white negative masking image onto a plane transferable foil (without pre-embossing of any pattern) using a conventional laser printer. The printing is done onto the aluminum side of the transfer foil.

Soaping the printed foil in diluted hydrochloric acid for a few seconds to dissolve the aluminum in the non-printed area.

Drying the foil with hot air.

Overlaying the printed transfer foil onto the HDOE that is made by permanent type of aluminized polyester foil, with aluminized sides facing each other.

Aligning the crosshairs on both foils using precision position registration apparatus.

Laminating the two foils together with heat and pressure under vacuum condition using the laminating machine.

Separating the two foils from each other. At this stage the toner particles together with the epoxy/aluminum layers in the transfer foil will have been transferred onto the HDOE foil, with precise image registration. This composite layer comprising toner particles, epoxy and aluminum, which will act to protect specific parts on the HDOE from any chemical reactions.

Soaping the HDOE foil into diluted hydrofluoric acid for a few seconds to dissolve all the aluminum on the non-imaged parts.

Laminating the HDOE foil onto a black paper substrate using transparent adhesive such as MP 467 double-sided cello-tape of 3M, with the side printed with toner particles facing the adhesive, to review the stereogram.

In another embodiment of the invention, an ink jet printer installed with image-on-paper facility is used to print a masking image directly onto the aluminum side of the HDOE film. In this method hydrofluoric acid solution is incorporated into the ink cartridge of the ink jet printer. With proper adjustment to the printing parameters (such as the volume of the droplets, the concentration of the Hydrofluoric solution and the thickness of the aluminized coating), the micro-droplets of Hydrofluoric solution may, upon being ejected onto the aluminized polyester HDOE film, quickly react with the aluminum to form minute powders of transparent aluminum oxide. The heat that is generated in the chemical reaction helps to vaporize the remaining water in the printed droplet within a few fraction of a second, thus prevent the droplet from coalescing with the neighboring ones. Said methods comprising steps of:

Preparing ink jet printer installed with image-on-paper facility.

Preparing ink cartridge with ink containing at least 10% solution of hydrofluoric acid.

Printing the negative masking image directly onto the aluminum side of the HDOE film.

Laminating the films using transparent adhesive on to a piece of black cardboard to review the stereogram.

In a further embodiment of the invention, a piece of polycarbonate HDOE film coated with a thin silver layer is used to make the stereogram master with an inkjet printer. The printer is preferably a flatbed type in order to accommodate the relatively thick print medium of polycarbonate. Said methods comprising steps of:

Preparing ink jet printer of flatbed type and is installed with image-on-paper facility.

Preparing ink cartridge with ink containing silver removing solution, namely a mixture of 5% sulfuric acid and 5% Potassium dichromate.

Printing the negative masking image directly onto the silver side of the HDOE film.

Rinsing the polycarbonate film in distill water

Utilizing this film as print master in embossing holography.

In yet another embodiment of the invention, a polycarbonate HDOE film that is doubly coated with first a thin silver layer and then a thin photo resist layer is used to make the stereogram master. The initial coating using silver is necessary because if the photoresist layer were to be coated directly onto the polycarbonate film it will chemically dissolve and damage the surface structure of the polycarbonate. A positive masking image, that is initially printed onto a transparent plastic film is then contact copied using UV light onto the doubly coated HDOE film with precision position registration manually.

After the latent image in the photoresist is being developed using the 1.5% solution of Sodium Hydroxide, the silver in that area on the HDOE film becomes unprotected. In a subsequently soaping of the film into solution mixing 5% sulfuric acid and 5% Potassium dichromate, the unprotected silver can be removed. This renders the surface relief pattern on the part that has been exposed to UV light entirely exposing to air. Now the HDOE film is having two surface features, one is the surface relief profile in the exposed area and the other is the smooth and mirror like surface of the un-exposed photoresist. Finally an additional coating of this film using silvering makes it to become a print master in the mass production process of embossed holography. The printing method comprising the steps of:

Coating the surface relief side of the polycarbonate HDOE film with a thin layer of silver.

Further coating a thin layer of photoresist on top of said silver layer.

Printing a positive masking image with cross hairs onto transparent plastic film using laser printer. The masking image is constructed of opaque and transparent area.

Overlay the film printed with masking image onto of the polyester HDOE film. The printed side is made to face the photoresist layer.

Aligning the two films (the printed transparent plastic film and the polycarbonate HDOE film) with precision registration, using the help of the cross hairs.

Bringing the two films into close contact with pressurized double-glass plates or vacuum suction forces.

Irradiating the films using UV light to contact print the positive masking image onto the photoresist.

Developing the latent image on the photoresist layer using 1.5% Sodium Hydroxide solution to completely remove the photoresist in the exposed area, thus reviewing a positive silver image on the polycarbonate film.

Further developing the polycarbonate film using silver removing agent (a mixture of 5% Sulfuric acid and Ammonia dichromate) to dissolve the silver layer in the exposed part (the part where the photoresist has been removed), thus exposing the surface relief diffraction pattern on the polycarbonate HDOE film to air.

(10) Removing the remaining photoresist with 1.5% of Sodium Hydroxide.

(11) Coating the PC film with silver at the imaged side.

(12) Utilizing said PC film as print master in embossed holography.

In yet a further embodiment of the invention, a metallic Nickel HDOE plate is employed to produce stereogram master. Said method comprises steps of:

(1) Treating the Nickel HDOE plate with activator (5% solution of Sulphamic

Acid) and passivator (2% Dichromate solution), cleaning with de-ionize water and then drying with hot air.

Coating a thin layer of positive photoresist 1603a over the image side of the nickel HDOE plate with proper baking.

Printing a positive masking image onto transparent plastic film.

Overlay the masking image onto of the Nickel plate with precision position registration under vacuum condition.

Contact printing the masking image onto the photoresist layer using UV light and precision alignment.

Developing the latent image using 1.5% of Sodium Hydroxide solution to completely remove the photoresist in the exposed area.

Sensitizing the plate with sensitizing chemicals containing solution of Hydrochloric acid and Tin Chloride.

Coating a layer of silver onto the nickel plate.

Electroforming and embossing the stereogram onto polyester foil to mass duplicating the images.

In another preferred embodiment of the present invention, there is provided with methods and devices to make holographic stereogram on aluminized polyester or BOPP film in roll form using conventional high-speed offset printer in a two-steps manner. The ink in the image area will act as protector to prevent the part of the aluminum underneath the ink from contacting to the chemical, while the aluminum in the part of foil where there is no image will be dissolved by the subsequent rinsing bath in dilute hydrofluoric acid, rendering that part non-reflective and become transparent. This method allows the holographic stereogram to be produced directly in large volume and at high speed using the existing machinery in the printing industry. Said method comprising the procedures of:

Using a black-and-white negative masking image as print master in the high-speed offset printing machine that is installed with image-on-paper precision printing facility.

Printing the masking image on the aluminum side of the roll form HDOE film.

Drying the print ink.

Soaping the printed foil in dilute hydrochloric acid for a few seconds.

Drying the film with hot air.

Laminate the foil onto any paper substrate using transparent adhesive such as MP 467 double-sided cello-tape of 3M, with the printed side facing the paper, to review the stereogram.

Having described and illustrated the mechanism of the technology with reference to specific implementations it will be recognized that the above detailed embodiments are exemplary only. The technology can be implemented in many other different forms, for example:

(a) Further to the six configurations, a CD-ROM burner type of technique can be adopted, of which the polycarbonate HDOE film with reflective aluminum coating and an additional dye layer are mass-produced using injection-molding machineries. Then the masking image is “written” or “burn” over the dye material using laser diodes, in the same manner and set up in the art of CD ROM burner.

(b) While hydrofluoric acid is recommended as an exemplary chemical substance for dissolving the aluminum of the HDOE film in this disclosure, any other agents reacting well with aluminum such as Sodium Hydroxide and Tin Chloride can be employed.

(c) The de-metal process can be performed using electrostatic sparks that burn away the unprotect part of aluminum on the HDOE foil.

(d) The HDOE can also be pre-embossed onto BOPP film or PVC film without affecting the quality of the image.

It should be appreciated by those skilled in the art that the descriptions disclosed above represent techniques discovered by the inventor to function well and thus can be considered to constitute exemplary modes for its practice. However, those with skills in the art will, judge from the present presentation, appreciate that many changes can be made in the specific embodiments which are disclosed and still obtain a similar or like result without departing from the scope and spirit of the invention.

What is claimed is:

1. A method of printing holographic stereogram using conventional black and white desktop electronic printers, said method comprising the steps of:
a. Preparing an universal holographic print medium hereinafter called the Holographic Diffractive Optical Element (HDOE) film;
c. Creating a masking image using software hereinafter named as Image Generating Software (IGS);
d. Incorporating said masking image onto said HDOE film using a direct or indirect method and
e. Removing the reflecting capability in those unwanted areas of the image on the HDOE film using chemical method, thus creating a holographic stereogram.

2. The HDOE film as claim in claim 2 comprising:
a. A plurality of microscopic array of optical elements and
b. A set of registration test pattern consisting of at least four crosshairs at precise dimension, separation and location.

3. The HDOE film according to claim 2;
Wherein the substrate material is preferably made of aluminized polyester with a thickness of at least 0.025 mm;
Wherein the substrate material is preferably made of polycarbonate with a thickness of at least 0.5 mm and
Wherein the substrate material is preferably made of Nickel metal with a thickness of at least 0.1 mm.

4. The Holographic Diffractive Optical Element (HDOE) as claim in claim 2;
Wherein the array of microscopic elements take the shape of either continuous straight lines, or square/rectangular dots;
Wherein said lines or dots are pre-embossed with rainbow hologram of a planar diffused object and
Wherein said lines or dots are pre-embossed with linear diffraction gratings.

5. The microscopic lines or dots as set forth in claim 4;
Wherein said lines or dots are arranged in alternatively interlacing manner and are evenly distributed into groups, each group contains elements diffracting at different colors and at different horizontal directions;
Wherein the dimension of each dot/line is preferable below the resolution of naked eyes, which is 0.1 mm or less and
Wherein the large plurality of dots or lines is arranged in a manner similar to those employed in the fluorescent tube of color video monitor screens or in LCD.

6. The HDOE according to claim 2, wherein said optical element is produced using a holographic dot matrix apparatus that is commonly used for mastering in the holographic industry.

7. The registration test pattern as claim in claim 3, further comprising a set of design parameters governing:
a. The dimension of the HDOE film along and perpendicular to the printing direction;
b. The distances between said crosshairs;
c. The distances between the crosshairs and the edges of the HDOE film and
d. Wherein said crosshairs are impressed onto HDOE film in the form of achromatic rainbow hologram or diffraction gratings using embossed holographic technique.

8. The computer program of IGS as claim in claim 2 for creating masking images; wherein said masking image represents the integration of all the sampling components of the original parallax images into one single complex entity in achromatic form; said software comprising the steps of:
a. Taking, scanning or inputting the sequential parallax 2D images into the computer;
b. Separating the color images into red green and blue components;
c. Transforming the image of each component into corresponding Black/White image;
d. Sampling the individual gray image component by using the same line width/dot size and spacing corresponding to the format in the HDOE as sampling pattern and
e. Integrating the sampled gray line-or-dot components to form one single composite masking image.

9. The process of making holographic stereogram as claim in claim 2, specifically on aluminized polyester HDOE film using laser printer in a two-steps process; said method comprising the steps of:
a. Preparing aluminized polyester HDOE film;
b. Using laser printer that is installed with facility for image-on-paper precision registration printing;
c. Printing said negative masking image on the aluminum side of said HDOE film;
d. Soaping the printed aluminized polyester film in at least 5% solution of Hydrofluoric acid for a few seconds to completely remove the aluminum in the unprinted area of the HDOE film;
e. Applying a thin layer of transparent adhesive to the aluminum side of the film and
f. Laminating the film onto a black paper or plastic cardboard.

10. The process of making holographic stereogram as claim in claim 2, specifically on aluminized polyester HDOE film using laser printer in a multiple-step process; said method comprising the steps of:
a. Printing a black-and-white negative masking image onto the aluminum side of a plane hot stamp foil;
b. Soaping the printed foil in diluted hydrochloric acid for a few seconds to dissolve the aluminum in the non-printed area;
c. Drying the foil with hot air;
d. Overlaying said printed hot stamp foil onto the HDOE that is made by permanent type of aluminized polyester foil, with aluminized sides facing each other;
e. Aligning the crosshairs on both foils;
f. Laminating the two foils together with heat and pressure under vacuum condition using laminating machine incorporated with precision position registration;
g. Separating the two foils from each other;
h. Soaping the HDOE foil into diluted hydrofluoric acid for a few seconds to dissolve all the aluminum on the non-image parts and
i. Laminating the HDOE foil onto a black paper substrate using transparent adhesive, with the side printed with toner particles facing the adhesive, to review the stereogram.

11. The process of making holographic stereogram as claim in claim 2, specifically on aluminized polyester HDOE film using ink jet printer, comprising the steps of:
a. Preparing aluminized polyester HDOE film;
b. Preparing ink jet printer that is installed with (A) facility for image-on-paper precision registration printing and (B) water solvable ink containing at least 10% solution of Hydrofluoric acid;
c. Printing the negative masking image onto the aluminum side of the HDOE film directly;
d. Applying a thin layer transparent adhesive to the aluminum side of the film and
e. Laminating the film onto a paper or plastic cardboard.

12. The process of making stereographic image as claim in claim 2, specifically on polycarbonate HDOE film using inkjet printer; said method comprising the steps of:
a. Preparing ink jet printer of flatbed type that is installed with image-on-paper facility;
b. Preparing ink cartridge with ink containing silver removing solution, namely a mixture of 5% sulfuric acid and 5% Potassium dichromate;
c. Printing the negative masking image directly onto the silver side of the HDOE film;
d. Rinsing the polycarbonate film in distill water and
e. Utilizing this film as print master in embossing holography.

13. The process of making stereographic image as claim in claim 2, specifically on polycarbonate HDOE film using any type of B/W printer; said method comprising the steps of:
a. Preparing a polycarbonate HDOE film;
b. Coating the surface relief side of the polycarbonate film with a thin layer of silver;
c. Further coating a layer of thin positive photoresist on top of the silver layer;
d. Printing a positive masking image onto transparent plastic film using any B/W printer;
e. Laying and aligning the masking film on top of the photoresist layer of the polycarbonate HDOE film with precision position registration inside a vacuum chamber;
f. Irradiating the films using UV light to contact print the positive masking image onto the photoresist;
g. Developing the latent image on the photoresist layer using 1.5% Sodium Hydroxide solution to remove all the photoresist in the image part until the silver layer is exposed;
h. Further developing the polycarbonate film using silver removing solution (a mixture of 5% Sulfuric acid and Ammonia dichromate) to dissolve the silver in the exposed part;
i. Coating the PC film with silver at the imaged side;
j. Electroforming said PC film to form a nickel print master and
k. Mass duplicating the stereogram onto aluminized polyester film using embossing technique.

14. The process of making holographic stereogram as claim in claim 2, specifically on Nickel HDOE film using any type of B/W printers, comprising steps of:
a. Preparing a nickel HDOE film;
b. Spraying the nickel plate with chemicals of passivator and activator;
c. Drying the plate with hot air;
d. Coating a thin layer of positive photoresist over the image side of the Nickel HDOE plate;
e. Printing a positive masking image onto transparent plastic film using any type of B/W printer;
f. Contact printing the masking image with precision alignment onto the photoresist layer of the Nickel plate using UV light with precision alignment under vacuum condition;
g. Developing the latent image using 1.5% of Sodium Hydroxide solution until all the photoresist at the exposed area is removed to review the metallic nickel plate;
h. Treating the plate with sensitizing solution for the subsequent silvering process;
i. Coating a layer of silver onto the plate and
j. Electroforming the silvered nickel plate to form print master in the embossed hologram production process.

15. The process of making holographic stereogram as claim in claim 2, specifically on aluminized polyester HDOE film using B/W offset printer installed with image-on-paper facility. Said method comprising steps of:
a. Using a black-and-white negative masking image as print master in the high-speed offset printing machine that is installed with image-on-paper precision printing facility;
b. Printing the masking image on the aluminum side of the roll form HDOE film;
c. Drying the print ink;
d. Soaping the printed foil in dilute hydrochloric acid for a few seconds;
e. Drying the film with hot air and
f. Laminate the foil onto any paper or plastic substrate using transparent adhesive to review the stereogram.

16. The HDOE film according to claim 2, claim 3, claim 10, claim 11, claim 14 and claim 15;
Wherein said substrate can be of any thermal plastic material such as BOPP and PVC.
